(19) United States
(12) Patent Application Publication
(10) Pub. No.: US 2023/0394623 A1
(43) Pub. Date: Dec. 7, 2023

(54) APPARATUS, METHODS, AND PROGRAM PRODUCTS FOR CONTROLLING A SIZE AND/OR PLACEMENT OF DISPLAY ITEMS ON DISPLAYS

(71) Applicant: Lenovo (Singapore) Pte. Ltd., New Tech Park (SG)

(72) Inventors: Justin Ringuette, Morrisville, NC (US); Sandy Collins, Durham, NC (US); Robert James Norton, JR., Raleigh, NC (US)

(21) Appl. No.: 17/833,779

(22) Filed: Jun. 6, 2022

(51) Int. Cl. G06T 3/40; G06F 3/14

(52) U.S. Cl. CPC G06T 3/40; G06F 3/1423; G06T 2200/24

(57) ABSTRACT

Apparatus, methods, and program products for controlling a size and/or placement of display items on displays. An apparatus includes a processor and a memory configured to store code executable by the processor to receive a request to present a graphical user interface (GUI) associated with an application program on a display couplable to the processor, retrieve a previously set scaling flag configured to identify how to present the GUI, generate the GUI for presentation on the display responsive to the retrieved scaling flag, and output the generated GUI to the display.

### FIELD OF THE INVENTION

The present invention relates generally to apparatuses, methods, and program products for controlling size and placement of graphical user interfaces (GUIs) between displays.

### BACKGROUND OF THE INVENTION

GUI placement on a virtual display (such as a PC monitor) are positioned and scaled by pixels but must respect physical size and placement for optimal user experience. When moving between displays of different sizes and pixel densities GUIs may overlap, be compressed too small for proper viewing, or expand to consume an undesirable amount screen space.

### SUMMARY OF THE INVENTION

In one embodiment, an apparatus includes a processor and a memory configured to store code executable by the processor to receive a request to present a graphical user interface (GUI) associated with an application program on a display couplable to the processor, retrieve a previously set scaling flag configured to identify how to present the GUI, generate the GUI for presentation on the display responsive to the retrieved scaling flag, and output the generated GUI to the display.

In one embodiment, a method includes receiving a request to present a graphical user interface (GUI) associated with an application program on to a display couplable to the processor, retrieving a previously set scaling flag configured to identify how to present the GUI, generating the GUI for presentation on the display responsive to the retrieved scaling flag, and outputting the generated GUI to the display.

In one embodiment, a computer program product includes a computer-readable storage medium configured to store code executable by a processor couplable to a display. The executable code is configured to cause the processor to receive a request to present on the display a graphical user interface (GUI) associated with an application program, retrieve a previously set scaling flag configured to identify how to present the GUI, generate the GUI for presentation on the display responsive to the retrieved scaling flag, and output the generated GUI to the display.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The invention will be more fully understood from the following detailed description taken in conjunction with the accompanying drawings, in which:

FIG. 1 is a schematic view of one embodiment of a computing system including a primary display and a secondary display;

FIG. 2 is a schematic diagram of the computing system of FIG. 1;

FIG. 3 is a schematic diagram of a window being displayed on the primary display and the secondary display by the computing system of FIG. 2 in a first embodiment;

FIG. 4 is a schematic diagram of a window being displayed on the primary display and the secondary display by the computing system of FIG. 2 in a second embodiment; and

FIG. 5 is a is a schematic flow chart diagram illustrating yet another embodiment of a method for controlling size and/or positioning of GUIs across multiple displays.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Various exemplary methods, systems, and devices are provided for controlling how GUIs are presented between multiple displays. In general, the methods, systems, and devices can allow movement of the GUIs back and forth between multiple electronic displays while keeping visually appealing size, orientation, and positioning of the GUIs in the display. In one embodiment, a display controller can be configured to display a display item, e.g., a graphical user interface (GUI), such as, without limitation, application windows, computer icons, virtual post-it notes onto one of the plurality of displays according to scaling instructions can be placed. In response to an instruction to move the display item from the first one of the displays to a second one of the displays, the display item is presented on the second display according to a previously saved sizing instruction. In this way, the display item can appear on the second display such that the display item is not expanded or reduced in size beyond a predefined desire. The display item can therefore be seamlessly displayed to a user. User experience can thus be improved by allowing a user to clearly visualize a display item on displays having different display properties, such as, without limitation, pixel density, display area size, or comparable display properties. The display item can be displayed on the second display in a position relative to the appearance of the display item on the first display or the display item can be displayed on the second display and a position absolute of the appearance of the display item on the first display.

A person skilled in the art will appreciate that the devices, systems, and methods disclosed herein can be implemented using one or more computing systems. The term “computing system” as used herein refers to any of a variety of digital data processing devices, e.g., laptop or notebook computers, tablet computers, server computers, cell phones, PDAs, gaming systems, televisions, radios, portable music players, and the like. The systems and methods disclosed herein can also be implemented in part or in full using software, which can be stored as an executable program or programs on one or more non-transitory computer-readable storage mediums. The term “display” as used herein refers to any of a variety of display devices, e.g., a liquid crystal display (LCD), a light-emitting diode (LED) screen, a cathode ray tube (CRT) screen, a touchscreen, a 3D screen, and the like. Additionally, the term “display” as used herein can refer to a display that is mounted in the same chassis or package as one or more other displays in the system, as well as to a display that is physically separate from one or more other displays in the system. A computing system can thus include multiple displays in a single chassis or package, or a computing system can include at least one display in a single chassis or package having one or more additional displays removably and replaceably operatively coupled to the single chassis or package, e.g., by cord, by wire, by wireless electronic connection, etc. The term “window” as used herein refers to a visual object on a display. The visual object can have any shape, e.g., rectangular, ovular, trapezoidal, irregular, etc., and can optionally contain a user interface allowing input thereto by a user, e.g., input by keyboard, by mouse, by touch, by electronic stylus, etc. Non-limiting examples of a display item include a box listing electronic file folder contents, a GUI display area for a program running on a computer (e.g., a music player, a video player, an image editor, an image viewer, a word processing program, etc.), a Microsoft® Windows GUI display area, a warning pop-up box, a post-it note item, or any image presented on a desktop of an operating system.

Elements discussed herein with reference to a computing system can generally be configured similar to like-named elements discussed herein.

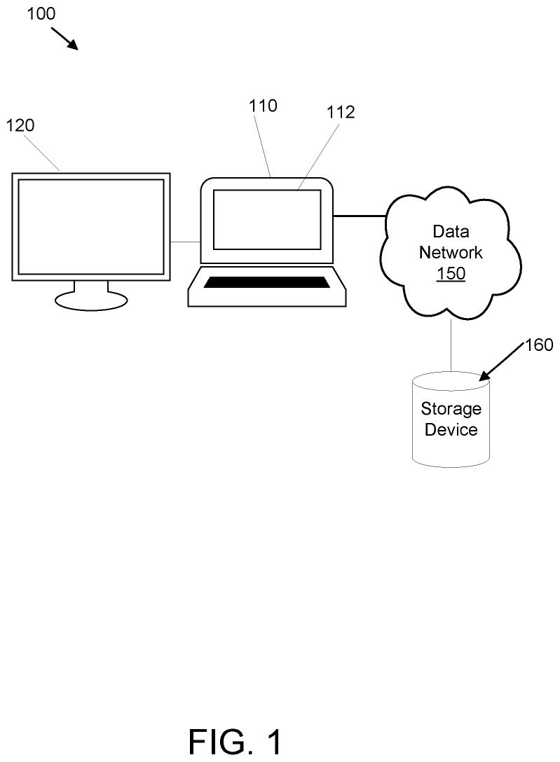

FIG. 1 illustrates one exemplary embodiment of a computing system 100 configured to control display of graphical user interfaces (GUIs) when moving the GUI between a system display 112 and an external display 120 configured to be operatively connected to the computing device (apparatus or system) 110. Also, the computing device 110 may communicate with a remote storage device 160 via a data network 150.

The computing device 110 can be configured to display an operating system desktop in which various GUI windows and other GUI display items/objects associated with application programs can be displayed. The GUIs can be moved between the system display 112 and the external display 120 based on previously stored scaling information for the application program associated with the GUI and/or information associated with the external display 120.

The computing device 110 can include any of a variety of software and/or hardware components. In addition, although the computing device 110 is depicted and described herein, a person skilled in the art will appreciate that this is for sake of generality and convenience. In other embodiments, the computing device 110 may differ in architecture and operation from that shown and described with respect to any of the illustrated embodiments.

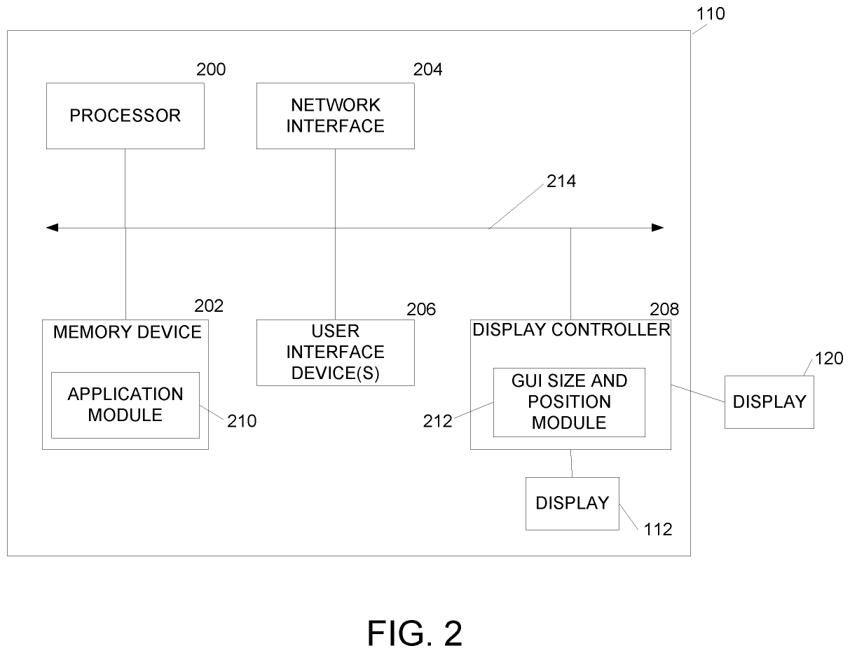

As shown in FIG. 2, the illustrated computing device 110 includes a processor 200 which controls the operation of the computing device 110, for example by executing an operating system (OS), a basic input/output system (BIOS), device drivers, application programs, and so forth. The processor 200 can include any type of microprocessor or central processing unit (CPU), including programmable general-purpose or special-purpose microprocessors and/or any one of a variety of proprietary or commercially-available single or multi-processor systems. The computing device 110 also includes a memory device 202, which can provide temporary storage for code to be executed by the processor 200 or for data that is produced by the processor 200. The memory device 202 can include read-only memory (ROM), flash memory, one or more varieties of random access memory (RAM), and/or a combination of memory technologies. The various elements of the computing device 110 are coupled to a data bus 214. The illustrated bus 214 is an abstraction that represents any one or more separate physical busses, communication lines/interfaces, and/or multi-drop or point-to-point connections, connected by appropriate bridges, adapters, and/or controllers.

The computing device 110 also includes the system display 112, a network interface 204, a user interface device(s) 206, the memory device 202, and a display controller 208. The network interface 204 can enable the computing device 110 to communicate with remote devices, e.g., other computing devices or the remote storage device 160 over the data network 150. The display controller 208 can control presentation of GUIs on the displays 112, 120. A person skilled in the art will appreciate that the computing device 110 can be configured to communicate with a variety of user interface devices 206. Non-limiting examples of user interface devices 206 include a keyboard, a touch screen, a mouse, a pointing device, a microphone, a camera, or comparable devices. The memory device 202 can include any conventional medium for storing data in a non-volatile and/or non-transient manner. The memory device 202 can thus hold data and/or instructions in a persistent state, i.e., the value is retained despite interruption of power to the computing device 110. The memory device 202 can include one or more hard disk drives, flash drives, universal serial bus (USB) drives, optical drives, various media disks or cards, and/or any combination thereof, and can be directly connected to the other components of the computing device 110 or remotely connected thereto, such as over the network 150 via the network interface 204. The display controller 208 can include a video processor and video memory and can generate images to be displayed on the displays 112, 120 in accordance with instructions received from the processor 200.

Although the system display 112 in the illustrated embodiment is included a laptop or notebook computer, and the external display 120 in the illustrated embodiment includes a standalone monitor device, the displays 112, 120 can include other types of displays, such as, without limitation, projectors or any device capable of presenting a computer-generated image. The external display 120 in the illustrated embodiment may be configured to be wirelessly operatively connected to the computing device 110, as will be appreciated by a person skilled in the art. The displays 112, 120 can be configured to operatively connect in other ways, such as with a wired connection or a combination of wired and wireless connections, as will also be appreciated by a person skilled in the art. The system display 112 in the illustrated embodiment has the processor 200 integrally formed therewith, e.g., disposed in a chassis or package thereof. A person skilled in the art will appreciate that the processor 200 need not be permanently disposed in the chassis or package to be integrally formed therewith (e.g., the processor 200 can be configured to be removed from the chassis or base, such by removing a motherboard including the processor 200 from the chassis or base.) In other embodiments, the external display 120 can have a processor integrally formed therewith. For example, the external display 120 may be included in a first tablet and the system display 112 may be included in a second tablet, or the displays 112, 120 are standalone monitors, which can be configured to operatively connect to the computing device 110.

The system display 112 can be operatively coupled to the display controller 208, which can provide images to be displayed on the system display 112. The system display 112 can be coupled to the system display 112 such that inputs performed on or recognized or detected by the system display 112 (e.g., touch inputs) can be received and processed by the processor 200. Software executed by the processor 200 can recognize or interpret inputs performed on or recognized or detected by the system display 112 as any of a variety of predetermined gestures, such as a tap gesture, a multi-tap gesture, a flick gesture, a drag gesture, a tap and hold gesture, a pinch gesture, a spread gesture, and so forth. Similarly, the external display 120 can be operatively coupled to the display controller 208, which can provide images to be displayed on the external display 120, and/or the external display 120 can be coupled to the display controller 208 such that inputs performed on or recognized or detected by the external display 120 can be received and processed by the processor 200.

One or more software modules can be executed by the computing device 110 to facilitate user interaction with the computing device 110. The software modules can be part of a single program or one or more separate programs, and can be implemented in a variety of contexts, e.g., as part of an operating system, a device driver, a standalone application, and/or combinations thereof. A person skilled in the art will appreciate that any software functions disclosed herein as being performed by a particular software module can also be performed by any other module or combination of modules. In an exemplary embodiment, the memory device 202 stores instructions within an application module 210 that when executed by the processor 200 causes the processor 200 to generate an image of a GUI associated with the application module 210 (i.e., the application program) based on a flag value for how to display the GUI image depending upon where and/or how the GUI image is to be displayed on the display that the GUI image is moved to or to be presented on.

Although two displays 112, 120 are shown in the system 100, the computing device 110 can include any number of displays configured to be operatively connected to the computing device 110 such that a GUI can be seamlessly scaled and/or positioned within the different displays 112, 120 as the GUI is moved there between.

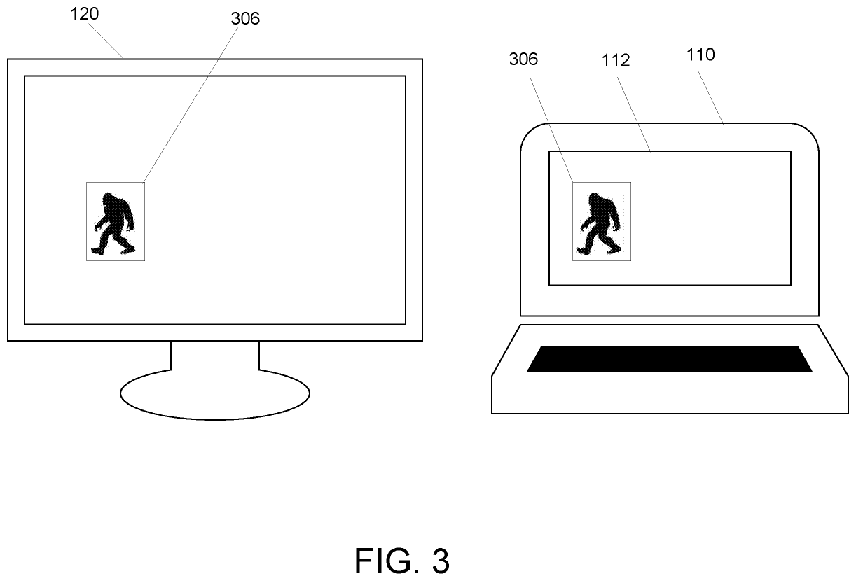

Referring to FIG. 3, in an illustrative embodiment, a photo application GUI 306 is to be displayed on or moved, either manually by the user interface device 206 (e.g., dragging and dropping the GUI 306) or automatically, from the system display 112 to the external display 120. The flag value stored in the application module 210 associated with the GUI 306, in a GUI size and position module 212 within the display controller 208, in the external storage device 160, or at some other location causes the processor 200 and/or the display controller 208 to generate the GUI 306 onto the external display 120 in a relative scaling manner. With regard to the relative scaling manner, the GUI 306 is repositioned according to a resolution value of the external display 120 so that the GUI 306 is located at the same location as the GUI 306 location previously presented in the system display 112. The display controller 208 and/or the processor 200 can detect, receive, and/or interpret input provided by the user via the user interface device 206 or the displays 112, 120 and communicate the input to the application module 210 or the GUI size and position module 212. The display controller 208 or the processor 200 can detect, receive, and/or interpret that the GUI 306 is to be presented on the external display 120 due to attaching the external display 120 to the computing device 110, such as during a duplicate multi-display mode where the desktop presented on the system display 112 is to presented on the external display 120.

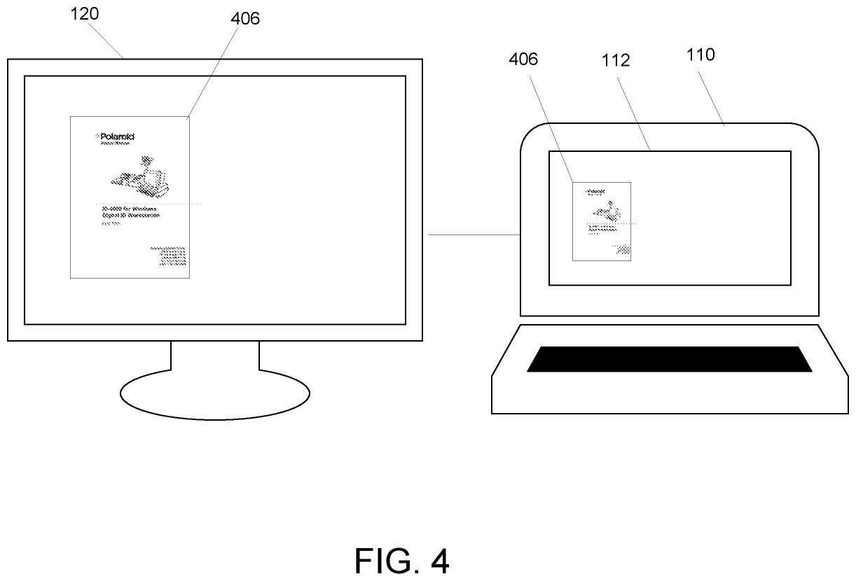

Referring to FIG. 4, in an illustrative embodiment, a text application GUI 406 is to be displayed or moved in a similar manner as the GUI 306 of FIG. 3 from the system display 112 to the external display 120. The flag value stored in the application module 210, in the GUI size and position module 212, in the external storage device 160, or at some other location causes the processor 200 and/or the display controller 208 to generate the GUI 406 onto the external display 120 in an absolute scaling manner. With regard to the absolute scaling manner, the GUI 406 is scaled up or down in order to exhibit similar size on the display regardless of the pixel resolution of the display. As shown, the GUI 406 is expanded in size due to the external display 120 being larger than the system display 112. Expansion of the GUI 406 may not affect the look of the GUI 406 because the GUI 406 is a text application program GUI where resolution does greatly reduce user experience upon scaling up in size. The display controller 208 and/or the processor 200 can detect, receive, and/or interpret input provided by the user via the user interface device 206 or the displays 112, 120 and communicate the input to the application module 210 or the GUI size and position module 212. The display controller 208 or the processor 200 can detect, receive, and/or interpret that the GUI 306 is to be presented on the external display 120 due to attaching the external display 120 to the computing device 110, such as during a duplicate multi-display mode where the desktop presented on the system display 112 is to presented on the external display 120.

In various embodiments. the flag value may be associated directly with a particular display or may be set according to particular display parameters. Thus, in the case where the flag value is based on particular display parameters, the display controller 208 and/or the processor 200 may retrieve a particular flag value based on determined parameters for the display a GUI is to be scaled to.

In various embodiments, the display controller 208 and/or the processor 200 may record and save in the memory device 202 and/or the remote storage 160 size and/or position information and/or associated display information of where the GUI is presented. This storage action may occur upon execution of a predefined action, such as, without limitation, closing the GUI, shutting down the computing device 110, turning a display off, or comparable events. The recorded size and/or position information may alter or be included in the previously stored flag value for use by the application module and/or the GUI size and position module 212 at a next time the associated GUI is to be presented on the associated display.

In various embodiments, instructions stored in the memory device 202 and/or the remote storage device 160 may instruct the processor 200 to present a prompt to a user requesting how to display the GUI on a particular one of the displays 112, 120. A user response to the prompt is recorded and saved at the memory device 202 and/or the remote storage device 160 and may be used by the application module 210 and/or the GUI size and position module 212 and a next time the application module 210 is being executed and the GUI associated with the application module 210 is to be displayed on a display not being used in a current session.

In various embodiments, further instructions stored in the memory device 202 and/or the remote storage device 160 may instruct the processor 200 to record GUI manipulation action(s) performed by a user, for example, resizing a GUI on the external display 120 differently from how the GUI was last scaled on to the external display 120. The recorded manipulation action(s) may be used by the application module 210 and/or the GUI size and position module 212 the next time the application module 210 is being executed and the GUI associated with the application module 210 is to be displayed on a display not being used in the current session.

The devices, systems, and methods disclosed herein are not limited to manipulating windows, but rather can be used to manipulate any of a variety of user interface objects, such as text, icons, controls, virtual sticky notes, etc.

Additionally, although only one GUI 306, 406 is shown displayed in FIGS. 3 and 4, any number of windows/GUIs can be simultaneously displayed on the system display 112 or on the external display 120.

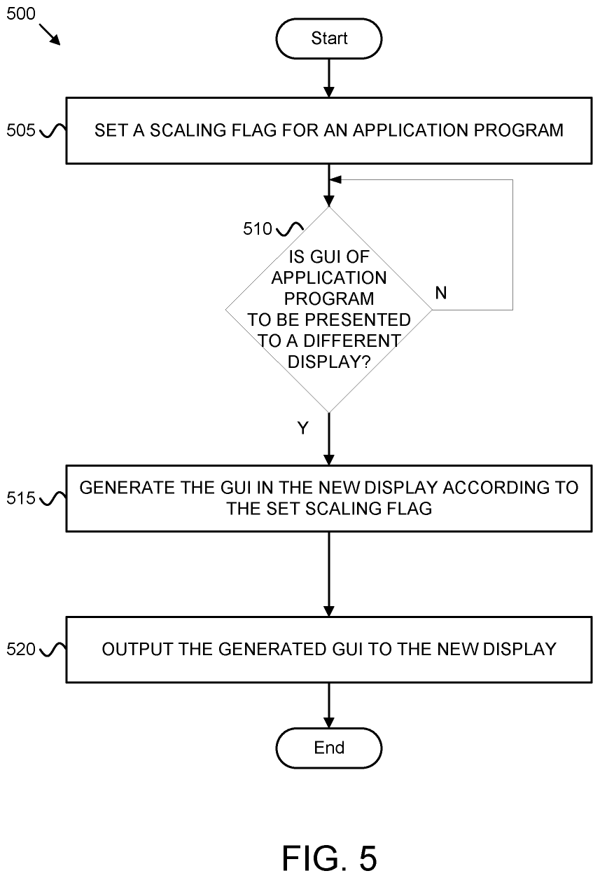

FIG. 5 is a schematic flow chart diagram illustrating one embodiment of a method 500 for controlling scaling of GUIs between displays. At a block 505, a scaling flag for an application program is set. At a decision block 510, a computing device determines whether a GUI of the application program is to be presented on a different display. If at the decision block 510, it is determined that the GUI is to be presented on a different display, then, at a block 515, the computing device generates the GUI for presentation on the different display according to the set scaling flag. At a block 520, the generated GUI is outputted to the new display.

In one embodiment, an apparatus, comprising: a processor; and a memory configured to store code executable by the processor to: receive a request to present a graphical user interface (GUI) associated with an application program on a display couplable to the processor; retrieve a previously set scaling flag configured to identify how to present the GUI; generate the GUI for presentation on the display responsive to the retrieved scaling flag; and output the generated GUI to the display.

In another embodiment, the flag indicates a display configuration chosen from an absolute positioning of the GUI and relative positioning of the GUI.

In still another embodiment, the absolute positioning of the GUI is based on default display location information within a display area.

In yet another embodiment, the relative positioning of the GUI is based on display information of the coupled display.

In a further embodiment, the code is further executable by the processor to receive information chosen from position information and size information of the GUI currently presented on the display and set the scaling flag responsive to the received information.

In still yet another embodiment, receiving the information indicating information chosen from position and size information of the GUI in the display is responsive to an ending action.

In still a further embodiment, the ending action is chosen from turning off the display, closing the associated application program, and turning off the processor.

In one embodiment, a method, comprising: receiving a request to present a graphical user interface (GUI) associated with an application program on to a display couplable to the processor; retrieving a previously set scaling flag configured to identify how to present the GUI; generating the GUI for presentation on the display responsive to the retrieved scaling flag; and outputting the generated GUI to the display.

In yet another embodiment, the method wherein the scaling flag indicates a display configuration chosen from an absolute positioning of the GUI and relative positioning of the GUI.

In still another embodiment, the method wherein generating the GUI comprises: generating the GUI at a size and a display location based on default size and display location information responsive to the scaling flag indicating the absolute positioning of the GUI.

In a further embodiment, the method wherein generating the GUI comprises: generating the GUI at a size and a display location based on size and display location information of the coupled display responsive to the flag indicating the relative positioning of the GUI.

In still yet another embodiment, the method further comprising receiving information chosen from size and display position information of the GUI currently presented on the display and setting the scaling flag responsive to the received information.

In still a further embodiment, the method further comprising receiving an ending action, and wherein receiving the information chosen from the size and position information of the GUI currently presented on the display is responsive to the received ending action.

In another embodiment, the method wherein the ending action is chosen from turning off the display, closing the associated application program, and turning off the processor.

In one embodiment, a computer program product comprising a computer-readable storage medium configured to store code executable by a processor couplable to a display, the executable code configured to cause the processor to: receive a request to present on the display a graphical user interface (GUI) associated with an application program; retrieve a previously set scaling flag configured to identify how to present the GUI; generate the GUI for presentation on the display responsive to the retrieved scaling flag; and output the generated GUI to the display.

In another embodiment, the computer program product wherein the scaling flag indicates a display configuration chosen from an absolute positioning of the GUI and relative positioning of the GUI.

In still another embodiment, the computer program product wherein: the absolute positioning of the GUI is based on default display location information within a display area; and the relative positioning of the GUI is based on display information of the coupled display.

In yet another embodiment, the computer program product wherein the code further causes the processor to receive information chosen from size and position information of the GUI currently presented on the display and set the scaling flag responsive to the received information.

In a further embodiment, the computer program product wherein receiving the information chosen from the size and position information of the GUI currently presented on the display is responsive to an ending action.

In still a further embodiment, the computer program product wherein the ending action is chosen from turning off the display, closing the associated application program, and turning off the processor.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a processor; and
a memory configured to store code executable by the processor to:
receive a request to present a graphical user interface (GUI) associated with an application program on a display couplable to the processor;
retrieve a previously set scaling flag configured to identify how to present the GUI;
generate the GUI for presentation on the display responsive to the retrieved scaling flag;
output the generated GUI to the display;
store information chosen from position information and size information of the GUI currently presented on the display responsive to closing the GUI, closing the associated application program, or shutting down the processor or the display; and
change the previously set scaling flag responsive to the stored information.

2. The apparatus of claim 1, wherein the flag indicates a display configuration chosen from an absolute positioning of the GUI and relative positioning of the GUI.

3. The apparatus of claim 2, wherein the absolute positioning of the GUI is based on default display location information within a display area.

4. The apparatus of claim 2, wherein the relative positioning of the GUI is based on display information of the coupled display.

5. (canceled)

6. (canceled)

7. The apparatus of claim 1, wherein storing is further responsive to turning off the display, closing the associated application program, and turning off the processor.

8. A method, comprising:
receiving a request to present a graphical user interface (GUI) associated with an application program on to a display couplable to the processor;
retrieving a previously set scaling flag configured to identify how to present the GUI;
generating the GUI for presentation on the display responsive to the retrieved scaling flag;
outputting the generated GUI to the display;
storing information chosen from position information and size information of the GUI currently presented on the display responsive to closing the GUI, closing the associated application program, or shutting down the processor or the display; and
changing the previously set scaling flag responsive to the stored information.

9. The method of claim 8, wherein the scaling flag indicates a display configuration chosen from an absolute positioning of the GUI and relative positioning of the GUI.

10. The method of claim 9, wherein generating the GUI comprises:
generating the GUI at a size and a display location based on default size and display location information responsive to the scaling flag indicating the absolute positioning of the GUI.

11. The method of claim 9, wherein generating the GUI comprises:
generating the GUI at a size and a display location based on size and display location information of the coupled display responsive to the flag indicating the relative positioning of the GUI.

12. (canceled)

13. (canceled)

14. The method of claim 8, wherein storing is further responsive to turning off the display, closing the associated application program, and turning off the processor.

15. A computer program product comprising a computer-readable non-transitory storage medium configured to store code executable by a processor couplable to a display, the executable code configured to cause the processor to:
receive a request to present on the display a graphical user interface (GUI) associated with an application program;
retrieve a previously set scaling flag configured to identify how to present the GUI;
generate the GUI for presentation on the display responsive to the retrieved scaling flag;
output the generated GUI to the display;
store information chosen from position information and size information of the GUI currently presented on the display responsive to closing the GUI, closing the associated application program, or shutting down the processor or the display; and
change the previously set scaling flag responsive to the stored information.

16. The computer program product of claim 15, wherein the scaling flag indicates a display configuration chosen from an absolute positioning of the GUI and relative positioning of the GUI.

17. The computer program product of claim 16, wherein:
the absolute positioning of the GUI is based on default display location information within a display area; and
the relative positioning of the GUI is based on display information of the coupled display.

18. (canceled)

19. (canceled)

20. The computer program product of claim 15, wherein storing is further responsive to turning off the display, closing the associated application program, and turning off the processor.
